(19) United States
(12) Patent Application Publication
(10) Pub. No.: US 2026/0044996 A1
(43) Pub. Date: Feb. 12, 2026

(54) IMAGE GENERATION DEVICE, IMAGE GENERATION METHOD, AND COMPUTER-READABLE RECORDING MEDIUM

(71) Applicant: NEC Corporation, Tokyo (JP)

(72) Inventor: Asuka ISHII, Tokyo (JP)

(73) Assignee: NEC Corporation, Tokyo (JP)

(21) Appl. No.: 19/274,836

(22) Filed: Jul. 21, 2025

(30) Foreign Application Priority Data
Aug. 7, 2024 (JP) 2024-131195

(51) Int. Cl. G06T 11/00; G06T 5/70; G06V 10/44; G06V 10/74

(52) U.S. Cl. CPC G06T 11/00; G06T 5/70; G06V 10/44; G06V 10/761; G06T 2207/20044; G06T 2207/20182

(57) ABSTRACT

An image generation device includes a feature value extraction unit that extracts a skeleton feature value of a skeleton from skeleton information specifying a position of each of joints constituting the skeleton, and an image generation unit that generates an image according to the skeleton by inputting the extracted skeleton feature value and a noise image to a machine learning model for estimating noise that has been added to the image and removing the noise from the image using an output result from the machine learning model.

### CROSS-REFERENCE TO RELATED APPLICATION

This application is based upon and claims the benefit of priority from Japanese patent application No. 2024-131195, filed on Aug. 7, 2024, the disclosure of which is incorporated herein in its entirety by reference.

### TECHNICAL FIELD

The present disclosure relates to an image generation device and an image generation method for performing image generation, and further relates to a computer-readable recording medium storing a program for achieving the image generation device and the image generation method.

### BACKGROUND ART

In recent years, image generation using image generation artificial intelligence (AI) has been proposed. The image generation AI can generate an image according to an input text, and thus is utilized in various fields such as web design, game design, and advertisement.

For example, examples of the image generation AI are disclosed in JP 2024-060907 A and Robin Rombach, Andreas Blattmann, Dominik Lorenz, Patrick Esser, Bjorn Ommer, “High-Resolution Image Synthesis with Latent Diffusion Models”, [online], arXiv: 2112.10752v2 [cs.CV], 13 Apr. 2022, [searched on May 1, 2024], Internet, <URL: https://arxiv.org/abs/2112.10752>. When text is input, an image related to the input text is generated using a machine learning model in image generation AI disclosed in JP 2024-060907 A and Robin Rombach, Andreas Blattmann, Dominik Lorenz, Patrick Esser, Bjorn Ommer, “High-Resolution Image Synthesis with Latent Diffusion Models”, [online], arXiv: 2112.10752v2 [cs.CV], 13 Apr. 2022, [searched on May 1, 2024], Internet, <URL: https://arxiv.org/abs/2112.10752>.

### SUMMARY

However, in the image generation AI disclosed in JP 2024-060907 A and Robin Rombach, Andreas Blattmann, Dominik Lorenz, Patrick Esser, Bjorn Ommer, “High-Resolution Image Synthesis with Latent Diffusion Models”, [online], arXiv: 2112.10752v2 [cs.CV], 13 Apr. 2022, [searched on May 1, 2024], Internet, <URL: https://arxiv.org/abs/2112.10752> described above, in a case where an image of a person is generated, only input of text is accepted, in such a way that there is a problem that a posture of the person in the image cannot be finely designated.

An object of the present disclosure is to enable designation of a posture of a person or the like in an image at the time of image generation.

In order to achieve the above object, an image generation device according to one aspect of the present disclosure includes a feature value extraction unit that extracts a skeleton feature value of a skeleton from skeleton information specifying a position of each of joints constituting the skeleton, and an image generation unit that generates an image according to the skeleton by inputting the extracted skeleton feature value and a noise image to a machine learning model for estimating noise that has been added to the image and removing the noise from the image using an output result from the machine learning model.

In order to achieve the above object, an image generation method according to one aspect of the present disclosure includes a feature value extraction step of extracting a skeleton feature value of a skeleton from skeleton information specifying a position of each of joints constituting the skeleton, and an image generation step of generating an image according to the skeleton by inputting the extracted skeleton feature value and a noise image to a machine learning model for estimating noise that has been added to the image and removing the noise from the image using an output result from the machine learning model.

Further, in order to achieve the above object, a computer-readable recording medium according to one aspect of the present disclosure storing a program including instructions for causing a computer to execute a feature value extraction step of extracting a skeleton feature value of a skeleton from skeleton information specifying a position of each of joints constituting the skeleton, and an image generation step of generating an image according to the skeleton by inputting the extracted skeleton feature value and a noise image to a machine learning model for estimating noise that has been added to the image and removing the noise from the image using an output result from the machine learning model.

As described above, according to the present disclosure, it is possible to designate the posture of the person or the like in the image at the time of image generation.

### BRIEF DESCRIPTION OF THE DRAWINGS

FIG. 1 is a configuration diagram illustrating a schematic configuration of an example of an image generation device;

FIG. 2 is a configuration diagram specifically illustrating a configuration of an example of the image generation device;

FIG. 3 is a configuration diagram illustrating a configuration of a noise estimation unit of the image generation device illustrated in FIG. 2 in detail;

FIG. 4 is a flowchart illustrating an example of the entire operation of the image generation device;

FIG. 5 is a flowchart illustrating an image generation step illustrated in FIG. 4 in detail;

FIG. 6 is a configuration diagram illustrating a configuration of an example of a learning model generation device;

FIG. 7 is a view illustrating an example of training data used for generating a learning model;

FIG. 8 is a flowchart illustrating an example of the operation of the learning model generation device;

FIG. 9 is a configuration diagram illustrating a configuration of an example of a learning model generation device for performing machine learning of a second machine learning model;

FIG. 10 is a view illustrating an example of a bone length vector and a bone length ratio vector;

FIG. 11 is a view illustrating an example of an angle vector obtained by concatenating a camera vector and a physique vector;

FIG. 12 is a view illustrating an example of parameter update processing in the learning model generation device illustrated in FIG. 9;

FIG. 13 is a flowchart illustrating an example of the operation of the learning model generation device illustrated in FIG. 9; and

FIG. 14 is a block diagram illustrating an example of a computer that achieves an image generation device and a learning model generation device.

### EXAMPLE EMBODIMENT

### First Example Embodiment

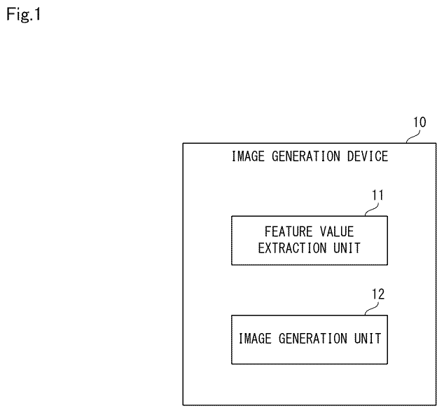

Hereinafter, an image generation device, an image generation method, and a program in a first example embodiment will be described with reference to FIGS. 1 to 5.

### [Device Configuration]

First, a schematic configuration of an example of the image generation device will be described with reference to FIG. 1. FIG. 1 is a configuration diagram illustrating the schematic configuration of the example of the image generation device.

An image generation device 10 illustrated in FIG. 1 is a device for generating an image of a person or the like according to a designated posture. As illustrated in FIG. 1, the image generation device 10 includes a feature value extraction unit 11 and an image generation unit 12.

The feature value extraction unit 11 extracts a skeleton feature value of a skeleton from skeleton information specifying a position of each of joints constituting the skeleton. The image generation unit 12 inputs the extracted skeleton feature value and a noise image to a machine learning model for estimating noise that has been added to an image. Then, the image generation unit 12 generates an image related to the skeleton by removing the noise from the image using an output result from the machine learning model.

As described above, the image generation device 10 can generate the image using the skeleton feature value extracted from the skeleton information instead of text. Therefore, a posture can be designated at the time of image generation according to the image generation device 10.

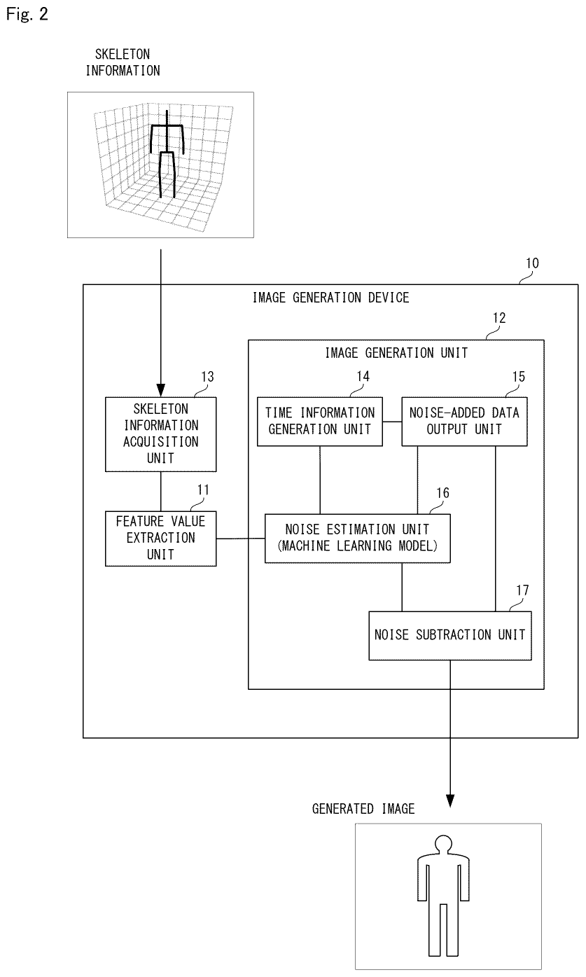

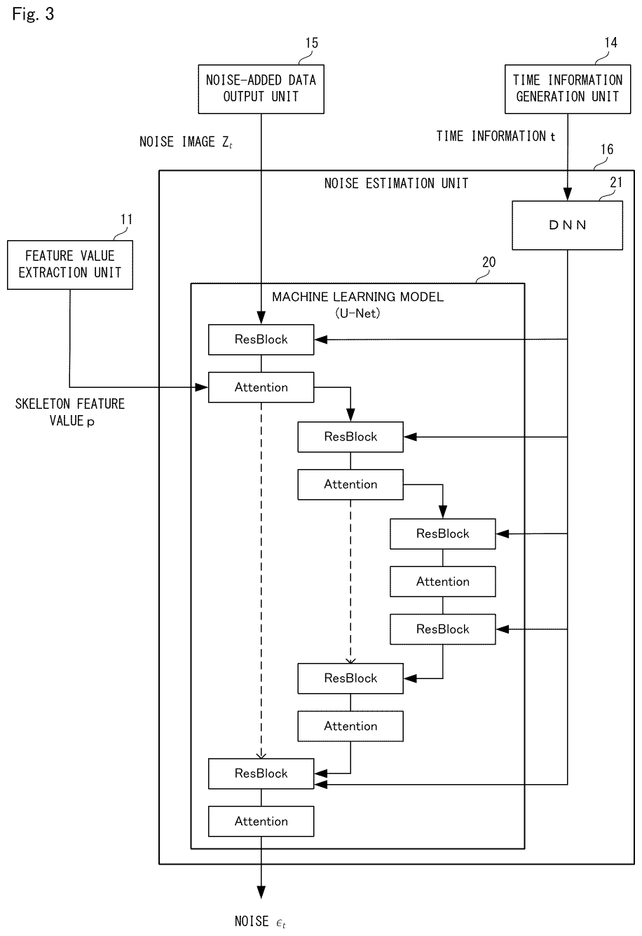

Next, a configuration and a function of the image generation device 10 will be specifically described with reference to FIGS. 2 and 3. FIG. 2 is a configuration diagram specifically illustrating a configuration of an example of the image generation device. FIG. 3 is a configuration diagram illustrating a configuration of a noise estimation unit of the image generation device illustrated in FIG. 2.

As illustrated in FIG. 2, the image generation device 10 includes a skeleton information acquisition unit 13 in addition to the feature value extraction unit 11 and the image generation unit 12 described above. The skeleton information acquisition unit 13 acquires skeleton information, and inputs the acquired skeleton information to the feature value extraction unit 11. The skeleton information is input by a user who requests image generation via a terminal device of the user.

The skeleton information is illustrated as a skeleton in the example of FIG. 2, but actually includes, for example, coordinates indicating a position of each of joint points of a person in image data. The origin of the coordinates of the joint points is set based on, for example, a camera. The skeleton information may further include information indicating a body shape (for example, a parameter indicating the degree of obesity or the like, information indicating a surface of a body as a basis of the skeleton, and the like.

In the first example embodiment, the feature value extraction unit 11 extracts a skeleton feature value from the skeleton information using a second machine learning model. The second machine learning model is a machine learning model trained in advance with a relationship between the skeleton information and the feature value. Examples of the second machine learning model include a neural network.

The second machine learning model can be implemented by a machine learning program executed on a computer. The second machine learning model may be implemented by a device (computer) different from the image generation device 10. Machine learning of the second machine learning model will be described in a third example embodiment.

As illustrated in FIG. 2, in the first example embodiment, the image generation unit 12 includes a time information generation unit 14, a noise-added data output unit 15, a noise estimation unit 16, and a noise subtraction unit 17. The image generation unit 12 removes noise stepwise from a noise image and finally generates a clear image having almost no noise.

For example, the time information generation unit 14 decreases a value of a time t from T (T: any value) to 0 at every setting interval, and outputs the value of the time t as time information. The output time information is input to the noise-added data output unit 15 and the noise estimation unit 16.

When the time information is input, the noise-added data output unit 15 generates image data of an image (noise image) to which noise has been added according to the value of the time t, and outputs the generated image data. Specifically, when the time t is equal to T, an initial noise image in which the entire surface is formed of only random noise is generated, and the image data is output to the noise estimation unit 16. When the time t is smaller than T, the noise-added data output unit 15 acquires the latest noise image from which noise has been removed by the noise subtraction unit 17 to be described later, and outputs the acquired noise image to the noise estimation unit 16.

The reason why the value of the time t changes between T and 0 is that images of training data used for learning of a machine learning model 20 to be described later are set in such a manner that noise is 0 when the time t=0 and the entire surface is noise when the time t=T as will be described in a second example embodiment to be described later.

As illustrated in FIG. 3, the noise estimation unit 16 includes the machine learning model 20 and a deep neural network (DNN) 21. Among these, the DNN 21 performs machine learning of a relationship between the time t and a feature value, and outputs a feature value (hereinafter, referred to as “time feature value”) related to time information when the time information is input. The output time feature value is input to the machine learning model 20. The noise estimation unit 16 may include a machine learning model other than the DNN 21. The machine learning model in this case may perform machine learning of the relationship between the time t and the feature value.

The machine learning model 20 is, for example, a model that executes an inverse spreading process on a noise image. In the example of FIG. 3, the machine learning model 20 is a neural network called U-Net. The machine learning model 20 is configured by concatenating a plurality of ResBlocks and a plurality of AttnBlocks in a U shape.

As illustrated in FIG. 3, a time feature value is input to each ResBlock, and a skeleton feature value p is input to each AttnBlock. A noise image Zₜ at the time t is input to the first ResBlock.

Specifically, the ResBlock is a module including a convolution layer, and performs conditioning based on the time t on the noise image Zₜ. The AttnBlock is a module including an attention layer, and performs conditioning on the noise image Zₜ based on skeleton information. As the ResBlock and the AttnBlock alternately perform processing, predicted noise eₜ is output from the final AttnBlock. As described above, the machine learning model 20 predicts the noise eₜ at the time t from the noise image, the skeleton feature value, and the time feature value, and outputs the predicted noise eₜ.

Details of U-Net are disclosed in, for example, https://github.com/CompVis/stable-diffusion.

The noise subtraction unit 17 receives the noise eₜ output from the noise estimation unit 16 and subtracts the received noise eₜ from the noise image at the time t. As a result, a noise image at a time (t+1) is generated. The noise-added data output unit 15 acquires the noise image generated by the noise subtraction unit 17 as described above, and outputs the acquired noise image to the noise estimation unit 16.

A series of processing by the time information generation unit 14, the noise-added data output unit 15, the noise estimation unit 16, and the noise subtraction unit 17 described above is repeatedly executed until the value of the time t changes from 0 to T. As a result, noise is removed stepwise from the noise image at the time t=0, and the clear image (hereinafter, referred to as “generated image”) having almost no noise is finally generated.

### [Device Operation]

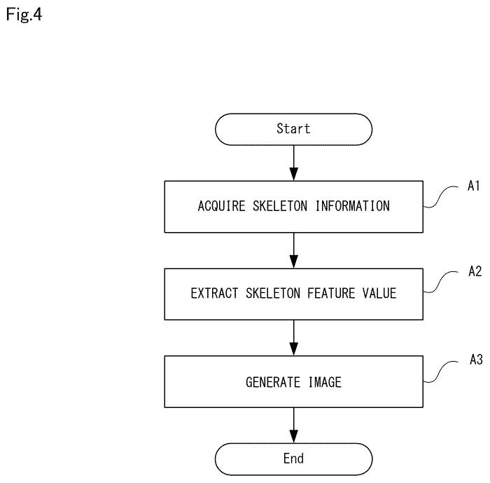

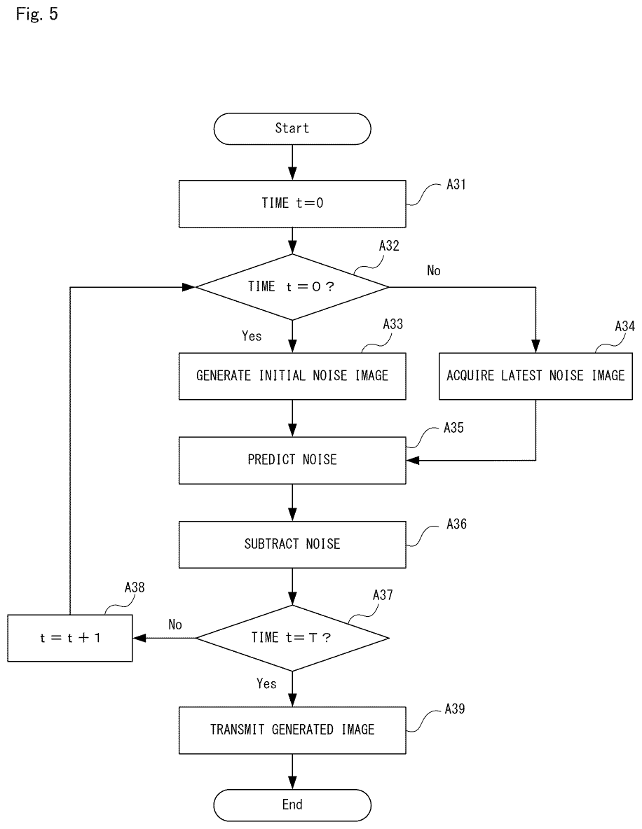

Next, an example of the operation of the image generation device will be described with reference to FIGS. 4 and 5. FIGS. 1 to 3 will be appropriately referred to in the following description. In the first example embodiment, the image generation method is performed by operating the image generation device 10. Therefore, in the first example embodiment, the description of the image generation method is replaced with the following description of the operation of the image generation device 10.

First, the entire operation of the image generation device 10 will be described with reference to FIG. 4. FIG. 4 is a flowchart illustrating an example of the entire operation of the image generation device.

As illustrated in FIG. 4, when the user who requests image generation first inputs skeleton information via the terminal device, the skeleton information acquisition unit 13 acquires the input skeleton information (step A1). The skeleton information acquisition unit 13 inputs the acquired skeleton information to the feature value extraction unit 11.

Next, the feature value extraction unit 11 extracts a skeleton feature value from the skeleton information using the second machine learning model (step A2). The feature value extraction unit 11 inputs the extracted skeleton feature value to the image generation unit 12.

Next, the image generation unit 12 inputs the skeleton feature value extracted in step A2 and a noise image to the machine learning model 20 (see FIG. 3), and removes noise from the image using an output result from the machine learning model 20, thereby generating an image related to a skeleton of the skeleton information (step A3). The generated image is transmitted to the terminal device of the user.

Next, an image generation step illustrated in FIG. 4 will be described in detail with reference to FIG. 5. FIG. 5 is a flowchart illustrating the image generation step illustrated in FIG. 4 in detail.

As illustrated in FIG. 5, at a timing when the skeleton feature value is input in step A2, the time information generation unit 14 sets a value of the time t to 0 and generates time information (step A31). Then, the time information generation unit 14 inputs the generated time information to the noise-added data output unit 15 and the noise estimation unit 16.

Next, the noise-added data output unit 15 determines whether the value of the time t in the time information is 0 (step A32). In a case where the value of the time t is 0 as a result of the determination in step A32, the noise-added data output unit 15 generates an initial noise image generated only with random noise and outputs image data thereof to the noise estimation unit 16 (step A33).

On the other hand, in a case where the value of the time t is larger than 0 as a result of the determination in step A32, the noise-added data output unit 15 acquires the latest noise image from which noise has been removed by the noise subtraction unit 17, and outputs the acquired noise image to the noise estimation unit 16 (step A34).

Next, the noise estimation unit 16 inputs the time information generated in step A31 to the DNN 21, and further inputs the skeleton feature value extracted in step A2 and the noise image output in step A33 or A34 to the machine learning model 20 to predict noise (step A35).

Next, the noise subtraction unit 17 subtracts the noise predicted in step A35 from the noise image output in step A33 or A34 (step A36). As a result, the latest noise image is generated.

Next, the noise subtraction unit 17 determines whether the value of the time t has reached a preset value T (step A37).

In a case where the value of the time t has not reached the preset value T as a result of the determination in step A37, the noise subtraction unit 17 increases the value of the time t by 1 (step A38).

Next, when step A38 is executed, the noise-added data output unit 15 executes step A32 again. As a result, step A32 and the subsequent steps are executed again.

On the other hand, in a case where the value of the time t has reached the preset value T as a result of the determination in step A37, the noise subtraction unit 17 transmits the latest noise image from which noise has been subtracted in step A36 as a generated image to the terminal device of the user (step A39). As a result, step A3 ends.

As described above, when steps A32 to A38 are executed a predetermined number of times, noise is removed stepwise from the initial noise image, and finally, a clear image (hereinafter, referred to as “generated image”) having almost no noise is generated.

As described above, according to the first example embodiment, the image of the person or the like can be generated according to the skeleton information, instead of text as in the related art. In the first example embodiment, the user can designate the posture of the person or the like by the skeleton information in the image generation.

As will be described in the second example embodiment to be described later, it is assumed that the resolution of image data to be training data is reduced by a variational autoencoder (VAE) encoder at the time of learning of the machine learning model 20. In this case, the image generation unit 12 may further include the VAE decoder, and executes decoding by the VAE decoder after execution of step A39.

### [Program]

In the first example embodiment, an example of a program may be a program that causes a computer to execute steps A1 to A3 illustrated in FIG. 4. The image generation device 10 and the image generation method can be achieved by installing and executing the program in the computer. In this case, a processor of the computer functions as the feature value extraction unit 11, the image generation unit 12, and the skeleton information acquisition unit 13, and performs processing. Examples of the computer include a smartphone and a tablet terminal device in addition to a general-purpose PC and a server computer.

Further, the program according to the first example embodiment may be executed by a computer system constructed by a plurality of computers. In this case, for example, each of the computers may function as any of the feature value extraction unit 11, the image generation unit 12, and the skeleton information acquisition unit 13.

### Second Example Embodiment

Next, in the second example embodiment, a learning model generation device, a learning model generation method, and a program for performing machine learning of the machine learning model 20 will be described.

### [Device Configuration]

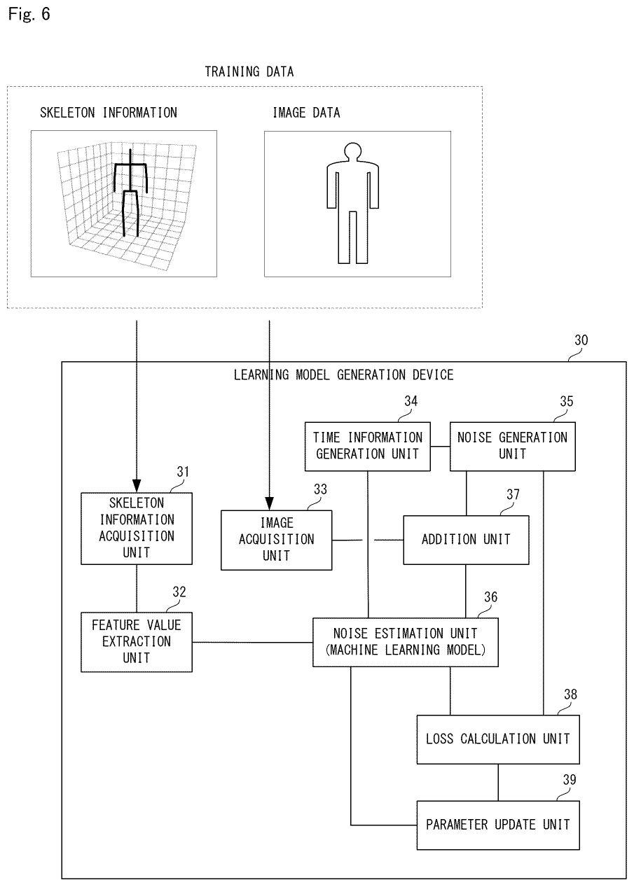

First, a configuration of an example of the learning model generation device will be described with reference to FIG. 6. FIG. 6 is a configuration diagram illustrating the configuration of the example of the learning model generation device.

A learning model generation device 30 illustrated in FIG. 6 is a device for performing the machine learning of the machine learning model 20 illustrated in FIG. 3. As illustrated in FIG. 6, the learning model generation device 30 includes a skeleton information acquisition unit 31, a feature value extraction unit 32, an image acquisition unit 33, a time information generation unit 34, a noise generation unit 35, a noise estimation unit 36, an addition unit 37, a loss calculation unit 38, and a parameter update unit 39.

The skeleton information acquisition unit 31 has the same function as the skeleton information acquisition unit 13 illustrated in FIG. 2. The skeleton information acquisition unit 31 acquires skeleton information to be training data, and inputs the acquired skeleton information to the feature value extraction unit 32. The skeleton information is input by a user who requests image generation via a terminal device of the user. The skeleton information is the same information as the skeleton information described in the first example embodiment.

The feature value extraction unit 32 has the same function as the feature value extraction unit 11 illustrated in FIG. 2. Also in the second example embodiment, the feature value extraction unit 32 extracts a skeleton feature value from the skeleton information using a second machine learning model. The feature value extraction unit 32 inputs the extracted skeleton feature value to the noise estimation unit 36. Similarly to the first example embodiment, the second machine learning model is a machine learning model trained in advance with a relationship between the skeleton information and the feature value.

The image acquisition unit 33 acquires image data to be training data, and inputs the acquired image data to the addition unit 37. The image data is data obtained by capturing a person or the like with a camera, and is output from the camera. The image data may be image data of a still image or image data of frames constituting a moving image.

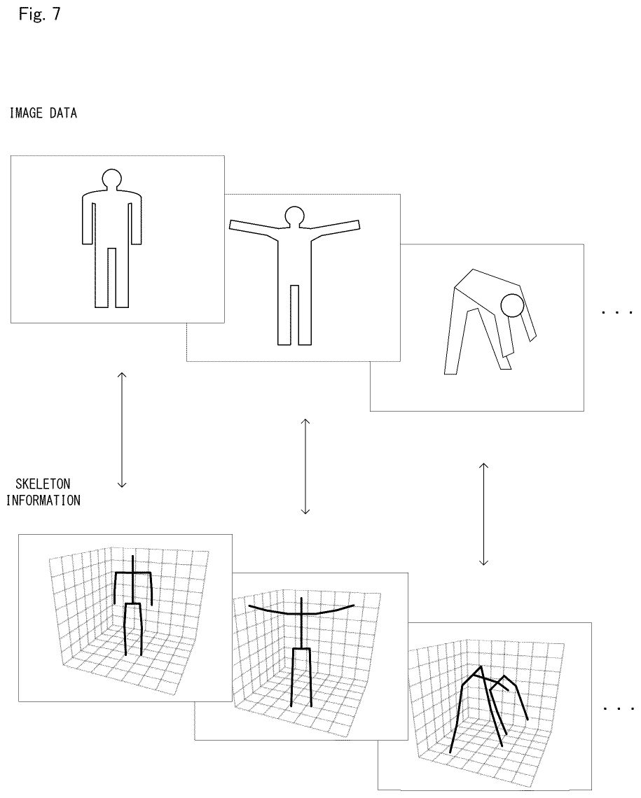

FIG. 7 is a view illustrating an example of training data used for generating a learning model. As illustrated in FIG. 7, the training data includes a set of image data and skeleton information related to each other. In the example of FIG. 7, an arrow indicates the image data and the skeleton information related to each other. In the training data, the image data is acquired by the image acquisition unit 33, and the skeleton information is acquired by the skeleton information acquisition unit 31.

The time information generation unit 34 randomly sets a value of a time t between 0 and T (T: any value), and outputs the set value of the time t as time information. The output time information is input to the noise generation unit 35 and the noise estimation unit 36.

When the time information is input, the noise generation unit 35 generates noise according to the value of the time t. Specifically, the noise generation unit 35 generates noise according to the value of the time t in such a way that the noise is 0 when the time t=0 and the entire surface of image data is noise when the time t=T. The noise generation unit 35 inputs the generated noise to the addition unit 37 and the loss calculation unit 38.

The addition unit 37 adds the noise generated by the noise generation unit 35 to image data input from the image acquisition unit 33. As a result, image data of a noise image to which the noise has been added according to the value of the time t is generated. The addition unit 37 inputs the generated noise image to the noise estimation unit 36.

The noise estimation unit 36 has the same configuration and function as those of the noise estimation unit 16 illustrated in FIGS. 2 and 3. Similarly to the example of FIG. 3, the noise estimation unit 36 also includes the machine learning model 20 and the deep neural network (DNN) 21. Therefore, the noise estimation unit 36 predicts noise at the time t from the noise image, the skeleton feature value, and a time feature value, similarly to the noise estimation unit 16 when the skeleton feature value, the time information, and the noise image are input to the noise estimation unit 36. The noise estimation unit 36 inputs the predicted noise to the loss calculation unit 38.

When the noise generated from the noise generation unit 35 is input and the noise predicted from the noise estimation unit 36 is input, the loss calculation unit 38 calculates a difference between the both. The calculated difference is a loss. The loss calculation unit 38 also inputs the calculated difference (loss) to the parameter update unit 39.

When the loss is input, the parameter update unit 39 updates a parameter of the machine learning model 20 in such a way that the loss becomes 0 or a value close to 0. At this time, the parameter update unit 39 can also update a parameter of the DNN 21 and further a parameter of the second machine learning model of the feature value extraction unit 32 based on the loss.

A series of processing by the skeleton information acquisition unit 31, the feature value extraction unit 32, the image acquisition unit 33, the time information generation unit 34, the noise generation unit 35, the noise estimation unit 36, the addition unit 37, the loss calculation unit 38, and the parameter update unit 39 described above is executed by setting the value of the time t between 0 and T for each set of the training data. As a result, when being used in an image generation device, the noise estimation unit 36 with the estimated parameter can generate an image from skeleton information with high accuracy.

### [Device Operation]

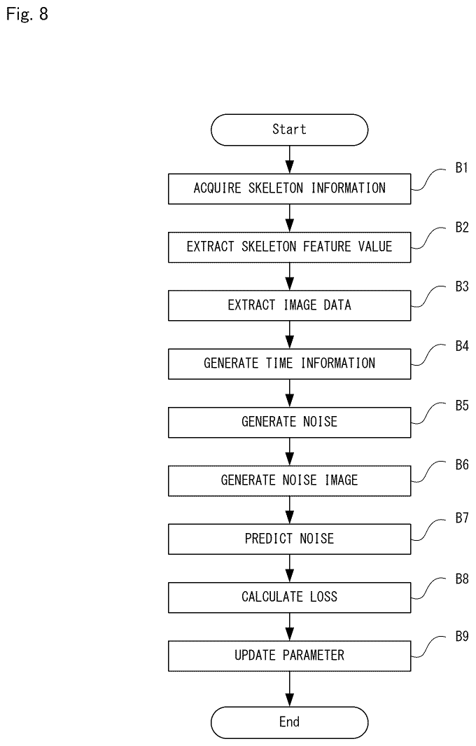

Next, an example of the operation of the learning model generation device will be described with reference to FIG. 8. FIG. 8 is a flowchart illustrating an example of the operation of the learning model generation device. In the following description, FIGS. 3, 6, and 7 will be appropriately referred to. In the second example embodiment, the learning model generation method is performed by operating the learning model generation device 30. Therefore, in the second example embodiment, the description of the learning model generation method is replaced with the following description of the operation of the learning model generation device 30.

First, as a premise, it is assumed that training data including a set of skeleton information and image data related to each other is prepared in advance in a database. In addition, it is assumed that the learning model generation device 30 is connected to the database in such a way as to be able to perform data communication.

As illustrated in FIG. 8, first, the skeleton information acquisition unit 31 acquires skeleton information to be training data (step B1). In step B1, the skeleton information acquisition unit 31 further inputs the acquired skeleton information to the feature value extraction unit 32.

Next, the feature value extraction unit 32 extracts a skeleton feature value from the skeleton information acquired in step B1 using the second machine learning model (step B2). In step B2, the feature value extraction unit 32 inputs the extracted skeleton feature value to the noise estimation unit 36.

Next, the image acquisition unit 33 acquires image data to be training data (step B3). In step B3, the image acquisition unit 33 inputs the acquired image data to the addition unit 37. Note that step B3 may be executed before step B1, or may be executed simultaneously with step B1. In order to reduce a processing load, the image acquisition unit 33 can also reduce the resolution of the acquired image data using a VAE encoder.

Next, the time information generation unit 14 generates time information according to a value of the time t (step B4). At this time, in a case where processing in step B4 and the subsequent steps has not been executed even once, the time information generation unit 14 sets the value of the time t to 0 to generate the time information. In step B4, the time information generation unit 14 inputs the time information to the noise generation unit 35 and the noise estimation unit 36.

Next, the noise generation unit 35 generates noise according to the value of the time t indicated by the time information generated in step B4 (step B5). In step B5, the noise generation unit 35 inputs the generated noise to the addition unit 37 and the loss calculation unit 38.

Next, the addition unit 37 adds the noise generated in step B5 to the image data acquired in step B3 to generate a noise image (step B6). In step B6, the addition unit 37 inputs the generated noise image to the noise estimation unit 36.

Next, the noise estimation unit 36 predicts noise at the time t from the noise image, the skeleton feature value, and a time feature value (step B7). In step B7, the noise estimation unit 36 inputs the predicted noise to the loss calculation unit 38.

Next, the loss calculation unit 38 calculates a difference (loss) between the noise generated in step B5 and the noise predicted in step B7 (step B8). In step B8, the loss calculation unit 38 inputs the calculated difference (loss) to the parameter update unit 39.

Next, the parameter update unit 39 updates a parameter of the machine learning model 20 in such a way that the loss calculated in step B8 becomes 0 or a value close to 0 (step B9). In step B9, the parameter update unit 39 can also update a parameter of the DNN 21 based on the loss.

After the execution of step B9, when there is training data that has not yet been used for updating the parameter, step B1 is executed again.

As described above, steps B1 to B9 are executed for each set of the training data, whereby the machine learning model 20 in the noise estimation unit 36 is subjected to the machine learning. As described above, it is possible to perform the machine learning of the machine learning model 20 used in the image generation device 10 according to the second example embodiment.

### [Program]

In the second example embodiment, an example of a program may be a program that causes a computer to execute steps B1 to B9 illustrated in FIG. 8. The learning model generation device 30 and the learning model generation method can be achieved by installing and executing the program in the computer. In this case, a processor of the computer functions as the skeleton information acquisition unit 31, the feature value extraction unit 32, the image acquisition unit 33, the time information generation unit 34, the noise generation unit 35, the noise estimation unit 36, the addition unit 37, the loss calculation unit 38, and the parameter update unit 39, and performs processing. Examples of the computer include a smartphone and a tablet terminal device in addition to a general-purpose PC and a server computer.

Further, the program according to the second example embodiment may be executed by a computer system constructed by a plurality of computers. In this case, for example, each of the computers may function as any of the skeleton information acquisition unit 31, the feature value extraction unit 32, the image acquisition unit 33, the time information generation unit 34, the noise generation unit 35, the noise estimation unit 36, the addition unit 37, the loss calculation unit 38, and the parameter update unit 39.

### Third Example Embodiment

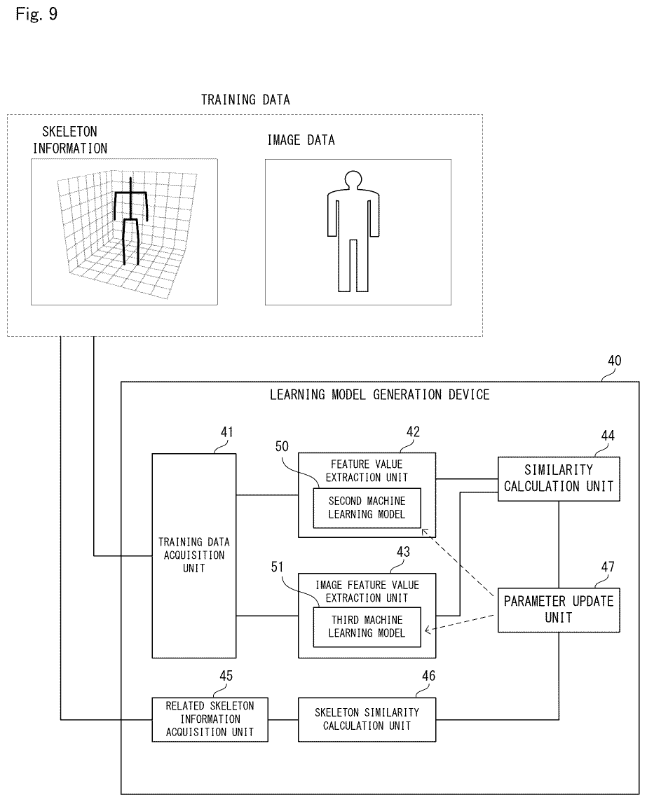

In the third example embodiment, a learning model generation device, a learning model generation method, and a program for performing machine learning of a second machine learning model used in a feature value extraction unit will be described with reference to FIGS. 9 to 13.

### [Device Configuration]

First, a schematic configuration of an example of the learning model generation device for performing the machine learning of the second machine learning model will be described with reference to FIGS. 9 to 12. FIG. 9 is a configuration diagram illustrating a configuration of the example of the learning model generation device for performing the machine learning of the second machine learning model.

A learning model generation device 40 illustrated in FIG. 9 is a device for performing machine learning of a second machine learning model 50. As illustrated in FIG. 9, the learning model generation device 40 includes a training data acquisition unit 41, a feature value extraction unit 42, an image feature value extraction unit 43, a similarity calculation unit 44, a related skeleton information acquisition unit 45, a skeleton similarity calculation unit 46, and a parameter update unit 47.

The training data acquisition unit 41 acquires training data. The training data is data similar to the training data described in the second example embodiment, and includes a set of image data and skeleton information related to each other (see FIG. 7).

Similarly to the second example embodiment, the image data is data obtained by capturing a person or the like with a camera, and is output from the camera. The image data may be image data of a still image or image data of frames constituting a moving image.

Similarly to the first and second example embodiments, for example, the skeleton information includes coordinates indicating a position of each of joint points of the person in the image data. The origin of the coordinates of the joint points is set based on, for example, the camera. The skeleton information may further include information indicating a body shape, information indicating a surface of a body as a basis of the skeleton, and the like.

The image data and the skeleton information related to each other are stored in a database or the like in an associated state. The association is performed by meta-information of each of the image data and the skeleton information stored together in the database or the like. Specifically, meta-information of image data includes an identifier of its related skeleton information, and meta-information of skeleton information includes an identifier of its related image data.

The feature value extraction unit 42 has the same function as the feature value extraction unit 11 illustrated in FIG. 2, and extracts a skeleton feature value from the skeleton information using the second machine learning model 50. The second machine learning model is trained with a relationship between the skeleton information and the feature value thereof by processing to be described below. Examples of the second machine learning model 50 include a neural network as described in the first and second example embodiments.

The image feature value extraction unit 43 extracts a feature value (hereinafter, referred to as “image feature value”) of the image data from the acquired image data using a third machine learning model 51. The third machine learning model 51 is trained with a relationship between the image data and the feature value thereof by processing to be described below. An example of the third machine learning model 51 is a neural network.

Hereinafter, a skeleton feature value is also referred to as “Tᵢ”, and an image feature value is also referred to as “Iⱼ”. Both i and j are integers from 1 to N (i, j=1, . . . and N), and are numbers assigned to image data and skeleton information which are to be training data. A value of N coincides with the number of pieces of each of the image data and the skeleton information to be the training data. Image data and skeleton information to which the same number is assigned are related to each other. That is, for example, a skeleton represented by the first skeleton information corresponds to a skeleton of a person illustrated in the first image data.

The similarity calculation unit 44 sets a combination of image data and skeleton information. Then, the similarity calculation unit 44 calculates a similarity sim(Tᵢ, Iⱼ) between the skeleton feature value Tᵢ and the image feature value Iⱼ for each set combination. Specifically, the similarity calculation unit 44 calculates a cosine similarity or a Euclidean distance as the similarity sim(Tᵢ, Iⱼ) using the skeleton feature value Tᵢ and the image feature value Iⱼ for each combination.

First, the related skeleton information acquisition unit 45 acquires meta-information of each piece of image data and the meta-information of each piece of skeleton information. Then, the related skeleton information acquisition unit 45 specifies skeleton information (related skeleton information) related to image data for which the similarity sim(Tᵢ, Iⱼ) is calculated using pieces of the acquired meta-information, and acquires the specified related skeleton information.

The skeleton similarity calculation unit 46 calculates a skeleton similarity S_{i,j} between the i-th related skeleton information and the j-th skeleton information for each combination set by the similarity calculation unit 44. Specifically, the skeleton similarity calculation unit 46 calculates, for example, a cosine similarity between coordinate values of joint points or a cosine similarity between angle vectors as the skeleton similarity S_{i,j}. The angle vector will be described later.

Here, a method of calculating the skeleton similarity S_{i,j} will be described in detail. First, in a case where the cosine similarity between coordinate values of joint points is calculated as the skeleton similarity S_{i,j}, the skeleton similarity calculation unit 46 calculates the skeleton similarity S_{i,j} using the following Formula 1. In the following Formula 1, Pᵢ indicates a coordinate value vector obtained from the coordinate value of each of the joint points included in the i-th related skeleton information. Pⱼ indicates a coordinate value vector obtained from the coordinate value of each of the joint points included in the j-th skeleton information.

$${S}_{i , j} = \frac{{P}_{i} \cdot {P}_{j}}{‖ {P}_{i} ‖ ‖ {P}_{j} ‖} \qquad [ Formula 1 ]$$

In a case where the cosine similarity between angle vectors is calculated as the skeleton similarity S_{i,j}, for example, the following processing is executed. First, the skeleton similarity calculation unit 46 obtains a camera posture vector for each piece of the image data serving as the training data. Examples of the camera posture vector include a vector indicating an angle formed by a direction of an optical axis of the camera and the vertical direction, and a vector indicating an angle formed by the optical axis of the camera and a part of the person. The camera posture vector may be obtained in advance for each piece of the image data.

Subsequently, the skeleton similarity calculation unit 46 calculates an average vector for the camera posture vectors of pieces of the image data. Here, the average vector is expressed as “camₘₑₐₙ”. Further, the skeleton similarity calculation unit 46 calculates a vector of the camera (hereinafter referred to as “camera vector”) used for capturing for each piece of the image data. For example, when a camera vector of Person A is expressed as “cam_{A}” and a camera vector of Person B is expressed as “cam_{B}”, the camera vectors are calculated by the following Formula 2.

$${cam}_{A} = {cam}_{mean} - [ \text{} Camera posture vector of camera capturing person A ] \qquad [ Formula 2 ]$$

$${cam}_{B} = {cam}_{mean} - [ \text{} Camera posture vector of camera capturing person B ]$$

Subsequently, for each piece of the skeleton information, the skeleton similarity calculation unit 46 calculates a bone length vector using coordinates of each of joints included in the skeleton information, and further calculates a “bone length ratio vector” from the calculated bone length vector.

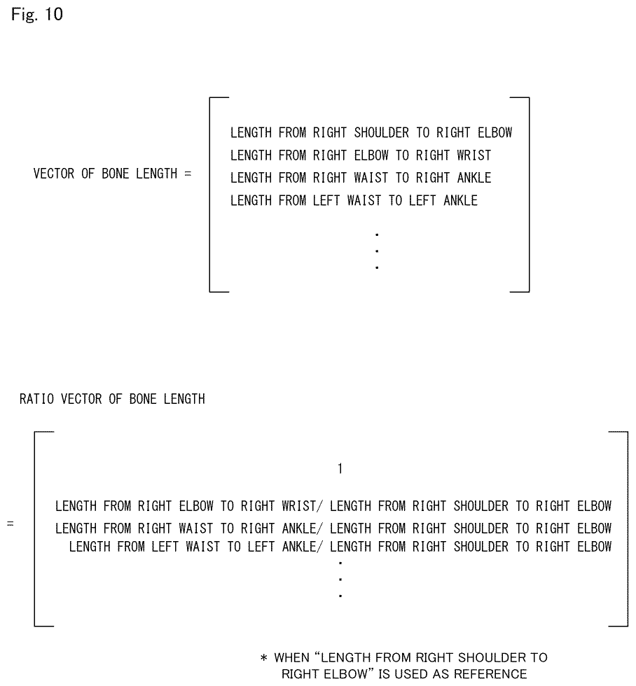

FIG. 10 is a view illustrating an example of the bone length vector and the bone length ratio vector. As illustrated in FIG. 10, the bone length vector includes “length from right shoulder to right elbow”, “length from right elbow to right wrist”, “length from right waist to right ankle”, “length from left waist to left ankle”, and the like. Each length is calculated from a difference in coordinate values (three-dimensional coordinates) between joints. The bone length ratio vector is calculated by dividing each length constituting the bone length vector by a reference length.

The skeleton similarity calculation unit 46 calculates an average vector for the length ratio vectors of bones of all persons who are targets of the skeleton information. Here, the average vector is expressed as “phyₘₑₐₙ”. Further, for each piece of the skeleton information, the skeleton similarity calculation unit 46 calculates a physique vector representing a physique of a target person using the average vector. For example, when a physique vector of Person A is expressed as “phy_{A}” and a physique vector of Person B is expressed as “phy_{B}”, the physique vectors are calculated by the following Formula 3.

$${phy}_{A} = {phy}_{mean} - [ Bone length ratio vector of person A ] \qquad [ Formula 3 ]$$

$${phy}_{B} = {phy}_{mean} - [ Bone length ratio vector of person B ]$$

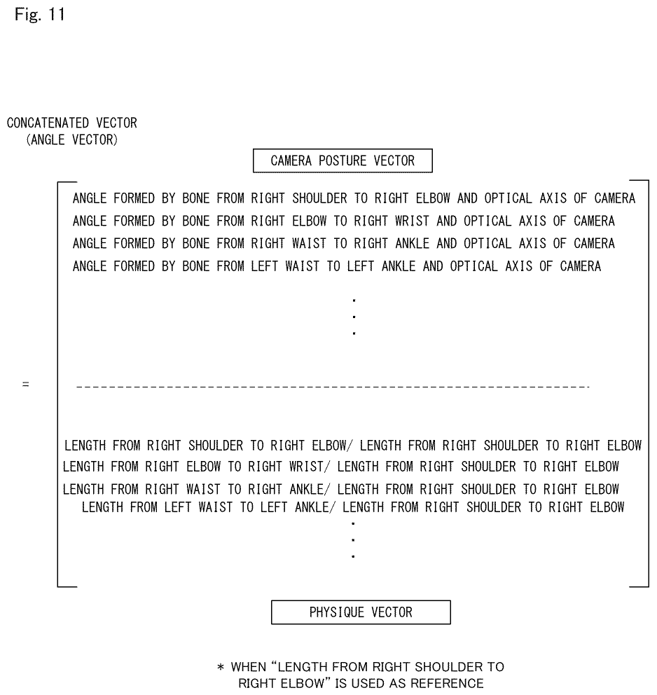

Subsequently, as illustrated in FIG. 11, the skeleton similarity calculation unit 46 concatenates the camera vector and the physique vector for each piece of the skeleton information. A vector obtained by the concatenation is the above-described “angle vector”. FIG. 11 is a view illustrating an example of the angle vector obtained by concatenating the camera vector and the physique vector.

Thereafter, the similarity calculation unit calculates the similarity between the angle vector obtained for the related skeleton information Ii and the angle vector obtained for the skeleton information Iⱼ for each combination set by the similarity calculation unit 44. Examples of the similarity include a cosine similarity (cos_sim(camᵢ+phyᵢ, camⱼ+phyⱼ)). The calculated similarity is the skeleton similarity S_{i,j}.

Further, the angle vector may be a vector indicating an angle formed by a bone connecting joint points and the optical axis of the camera. In this case, the skeleton similarity calculation unit 46 first calculates a vector b_{k,l} representing the bone connecting the joint points. Specifically, the vector b_{k,l} is represented by a difference in three-dimensional coordinate values for each of combinations of two joint points (k, l) as expressed in the following Formula 4.

$${b}_{k , l} = {P}_{k} - {P}_{l} \qquad [ Formula 4 ]$$

The combinations of the joint points (k, l) are set in advance. The combinations of the joint points (k, l) may be set as natural combinations indicating a skeleton of a person, or may be combinations of randomly selected joint points.

Next, the skeleton similarity calculation unit 46 acquires a vector C indicating the direction of the optical axis of the camera. It is assumed that the vector C is measured in advance. When the coordinate value vectors P of the joint points are expressed in a camera coordinate system, C is expressed as (0, 0, 1).

Further, the skeleton similarity calculation unit 46 calculates an angle θ_{k,l}, formed by the vector C indicating the direction of the optical axis of the camera and the vector b_{k,l} indicating the bone connecting the joint points, using the following Formula 5.

$${θ}_{k , l} = arccos ( C \cdot {b}_{k , l} / ‖ C ‖ ‖ {b}_{k , l} ‖ ) \qquad [ Formula 5 ]$$

The skeleton similarity calculation unit 46 executes the calculation of the vector b_{k,l}, the acquisition of the vector C indicating the direction of the optical axis of the camera, and the calculation of the angle θ_{k,l}, described above, for all the combinations of the joint points (k, l). Then, the skeleton similarity calculation unit 46 creates a vector Θ by arranging the obtained angles θ_{k,l} in order as expressed in the following Formula 6.

$$Θ = [ {\partial }_{1 , 2} , {\partial }_{2 , 3} , … , {\partial }_{7 , 8} ] \qquad [ Formula 6 ]$$

The skeleton similarity calculation unit 46 performs the above-described processing on all pieces of the training data to create the vectors Θ.

Subsequently, the similarity calculation unit 44 calculates a similarity between the vectors Θ as the skeleton similarity S_{i,j} for each combination of the image data and the skeleton information as expressed in the following Formula 7.

$${S}_{i , j} = {Θ}_{i} \cdot {Θ}_{j} / ‖ {Θ}_{i} ‖ ‖ {Θ}_{j} ‖ \qquad [ Formula 7 ]$$

The parameter update unit 47 calculates a difference between the similarity sim(Tᵢ, Iⱼ) and the skeleton similarity S_{i,j} for each combination set by the similarity calculation unit 44. Then, the parameter update unit 47 updates parameters of the second machine learning model 50 and the third machine learning model 51 in such a way that the calculated difference becomes 0 or close to 0. The parameter update unit 47 can also normalize the skeleton similarity S_{i,j} before calculating the difference to match a value range thereof with a value range of the similarity sim(Tᵢ, Iⱼ).

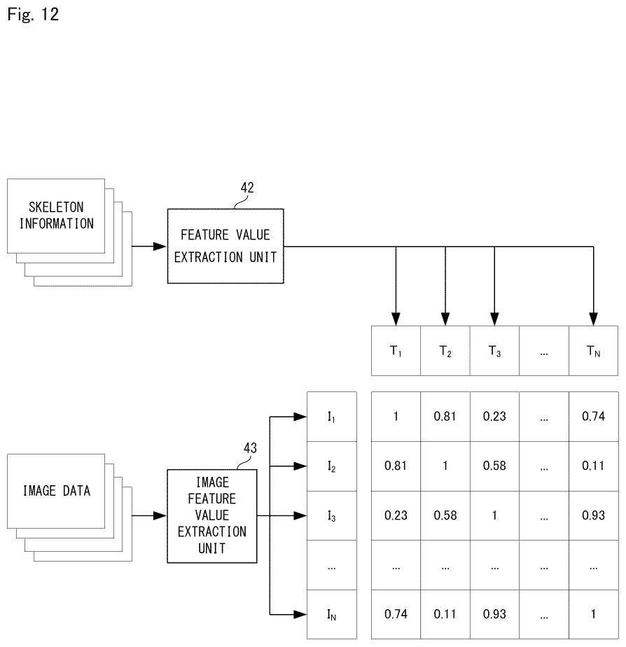

The parameter update will be specifically described with reference to FIG. 12. FIG. 12 is a view illustrating an example of parameter update processing in the learning model generation device illustrated in FIG. 9. In FIG. 12, numerical values indicated in a matrix indicate the skeleton similarities S_{i,j} calculated by the skeleton similarity calculation unit 46. The parameter update unit 47 updates parameters of the second machine learning model 50 and the third machine learning model 51 in such a way that the similarity sim(Tᵢ, Iⱼ) between the skeleton feature value Tᵢ and the image feature value Iⱼ becomes corresponding values on the matrix.

### [Device Operation]

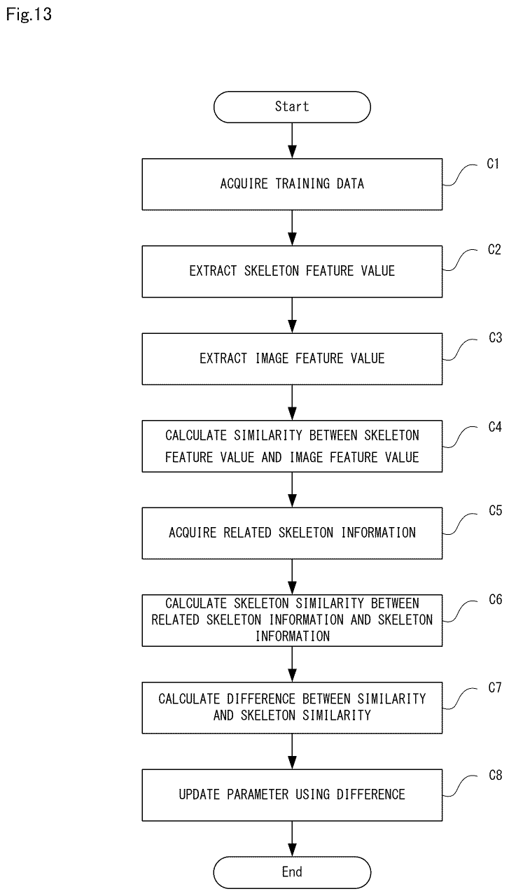

Next, the operation of the learning model generation device 40 will be described with reference to FIG. 13. FIG. 13 is a flowchart illustrating an example of the operation of the learning model generation device illustrated in FIG. 9. In the following description, FIGS. 9 to 12 will be appropriately referred to. In the third example embodiment, the learning model generation method is performed by operating the learning model generation device 40. Therefore, the description of the learning model generation method in the third example embodiment is replaced with the following description of the operation of the learning model generation device 40.

As illustrated in FIG. 13, first, the training data acquisition unit 41 acquires training data from the database (step C1). Then, the training data acquisition unit 41 inputs image data acquired as the training data to the image feature value extraction unit 43, and inputs skeleton information acquired as the training data to the feature value extraction unit 42.

Next, when the skeleton information is input, the feature value extraction unit 42 extracts a skeleton feature value using the second machine learning model 50 (step C2). The feature value extraction unit 42 outputs the extracted skeleton feature value to the similarity calculation unit 44.

Next, when the image data is input, the image feature value extraction unit 43 extracts an image feature value using the third machine learning model 51 (step C3). The image feature value extraction unit 43 outputs the extracted image feature value to the similarity calculation unit 44.

Next, the similarity calculation unit 44 calculates the similarity sim(Tᵢ, Iⱼ) between the skeleton feature value Tᵢ extracted in step C2 and the image feature value Iⱼ extracted in step C3 for each combination of the image data and the skeleton information (step C4).

Next, for each piece of the image data acquired in step C1, the related skeleton information acquisition unit 45 acquires skeleton information (related skeleton information) related to a person in the image data (step C5).

Specifically, in step C5, the related skeleton information acquisition unit 45 acquires meta-information of each piece of the image data and meta-information of each piece of the skeleton information. Then, the related skeleton information acquisition unit 45 specifies skeleton information (related skeleton information) related to image data for which the similarity sim(Tᵢ, Iⱼ) is calculated using pieces of the acquired meta-information, and acquires the specified related skeleton information.

Next, the skeleton similarity calculation unit 46 calculates the skeleton similarity S_{i,j} between the related skeleton information and the skeleton information for each combination of the image data and the skeleton information (step C6).

Next, the parameter update unit 47 calculates a difference between the similarity sim(Tᵢ, Iⱼ) and the skeleton similarity S_{i,j} for each combination of the image data and the skeleton information (step C7). Then, the parameter update unit 47 updates parameters of the second machine learning model 50 and the third machine learning model 51 using the difference calculated in step C7 (step C8).

As described above, according to the third example embodiment, the machine learning of each of the second machine learning model 50 and the third machine learning model 51, that is, the update of the parameters can be executed using the image data and the skeleton information as the training data. In addition, it is possible to determine a posture of a person from the image data by using the second machine learning model 50 and the third machine learning model 51.

### [Program]

In the third example embodiment, examples of the program include a program for causing a computer to execute steps C1 to C8 illustrated in FIG. 13. The learning model generation device 40 and the learning model generation method can be achieved by installing and executing the program in the computer. In this case, a processor of the computer functions as the training data acquisition unit 41, the image feature value extraction unit 43, the feature value extraction unit 42, the similarity calculation unit 44, the related skeleton information acquisition unit 45, the skeleton similarity calculation unit 46, and the parameter update unit 47, and performs processing. Examples of the computer include a smartphone and a tablet terminal device in addition to a general-purpose PC and a server computer.

In the third example embodiment, the program may be executed by a computer system constructed by a plurality of computers. In this case, for example, each of the computers may function as any of the training data acquisition unit 41, the image feature value extraction unit 43, the feature value extraction unit 42, the similarity calculation unit 44, the related skeleton information acquisition unit 45, the skeleton similarity calculation unit 46, and the parameter update unit 47.

### [Physical Configuration]

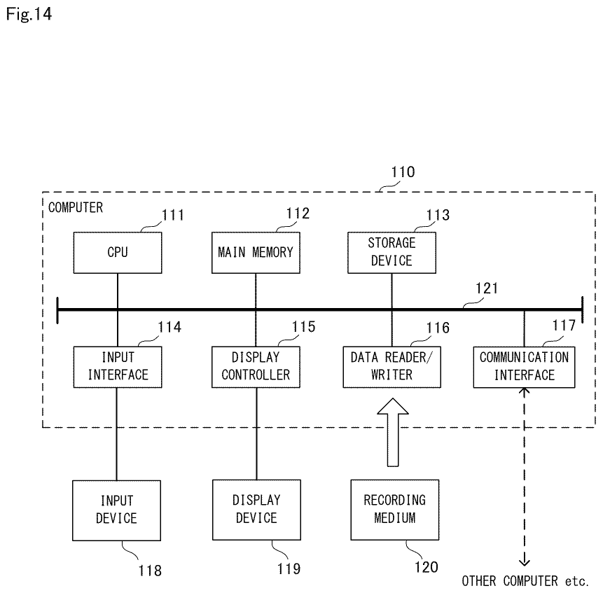

Here, a computer that achieves an image generation device and a learning model generation device by executing the programs in the respective example embodiments will be described with reference to FIG. 14. FIG. 14 is a block diagram illustrating an example of the computer that achieves the image generation device and the learning model generation device.

As illustrated in FIG. 14, a computer 110 includes a central processing unit (CPU) 111, a main memory 112, a storage device 113, an input interface 114, a display controller 115, a data reader/writer 116, and a communication interface 117. These units are data-communicably connected to each other via a bus 121.

The computer 110 may include a graphics processing unit (GPU) or a field-programmable gate array (FPGA) in addition to the CPU 111 or instead of the CPU 111. In this aspect, the GPU or the FPGA can execute the program in the example embodiment.

The CPU 111 develops the program according to the example embodiment, which is stored in the storage device 113 and configured by a code group, in the main memory 112, and executes each code in a predetermined order to perform various operations. The main memory 112 is typically a volatile storage device such as a dynamic random access memory (DRAM).

The programs according to the example embodiments are provided in a state of being stored in a computer-readable recording medium 120. The program in each of the present example embodiments may be distributed on the Internet connected via the communication interface 117.

Specific examples of the storage device 113 include a semiconductor storage device such as a flash memory in addition to a hard disk drive. The input interface 114 mediates data transmission between the CPU 111 and the input device 118 such as a keyboard and a mouse. The display controller 115 is connected to a display device 119 and controls display on the display device 119.

The data reader/writer 116 mediates data transmission between the CPU 111 and the recording medium 120, and reads a program from the recording medium 120 and writes a processing result in the computer 110 to the recording medium 120. The communication interface 117 mediates data transmission between the CPU 111 and another computer.

Specific examples of the recording medium 120 include general-purpose semiconductor storage devices such as a compact flash (registered trademark which is abbreviated to CF) and secure digital (SD), a magnetic recording medium such as a flexible disk, and an optical recording medium such as a compact disk read only memory (CD-ROM).

The image generation device and the learning model generation device can also be achieved by using hardware corresponding to each unit, for example, an electronic circuit, instead of a computer in which a program is installed. Furthermore, a part of the image generation device and the learning model generation device may be achieved by a program, and the remaining part may be achieved by hardware. In each of the example embodiments, the computer is not limited to the computer illustrated in FIG. 14.

Some or all of the above-described example embodiments can be expressed by (Supplementary Note 1) to (Supplementary Note 15) described below, but are not limited to the following description.

### (Supplementary Note 1)

An image generation device including:
a feature value extraction unit configured to extract a skeleton feature value of a skeleton from skeleton information specifying a position of each of joints constituting the skeleton; and
an image generation unit configured to generate an image according to the skeleton by inputting the extracted skeleton feature value and a noise image to a machine learning model for estimating noise that has been added to the image and removing the noise from the image using an output result from the machine learning model.

### (Supplementary Note 2)

The image generation device according to Supplementary Note 1, wherein
the skeleton information includes at least one of information specifying coordinates indicating positions of joint points, information indicating a body shape, and information indicating a surface of a body that is a basis of the skeleton.

### (Supplementary Note 3)

The image generation device according to Supplementary Note 1, wherein
the feature value extraction unit extracts the skeleton feature value of the skeleton using a second machine learning model obtained by machine learning of a relationship between the skeleton information and the skeleton feature value.

### (Supplementary Note 4)

The image generation device according to Supplementary Note 3, wherein
a parameter of the second machine learning model is updated by
calculating a similarity between a feature value of related image data and a feature value extracted from skeleton information, to be a sample, for each of combinations each of which is configured by combining the skeleton information to be the sample and the related image data,
further calculating a similarity between related skeleton information related to a person in the related image data and the skeleton information as a skeleton similarity for each of the combinations, and
further calculating a difference between the calculated similarity and the skeleton similarity for each of the combinations and using the calculated difference.

### (Supplementary Note 5)

An image generation method including:
a feature value extraction step of extracting a skeleton feature value of a skeleton from skeleton information specifying a position of each of joints constituting the skeleton; and
an image generation step of generating an image according to the skeleton by inputting the extracted skeleton feature value and a noise image to a machine learning model for estimating noise that has been added to the image and removing the noise from the image using an output result from the machine learning model.

### (Supplementary Note 6)

The image generation method according to Supplementary Note 5, wherein
the skeleton information includes at least one of information specifying coordinates indicating positions of joint points, information indicating a body shape, and information indicating a surface of a body that is a basis of the skeleton.

### (Supplementary Note 7)

The image generation method according to Supplementary Note 5, wherein
the feature value extraction step includes extracting the skeleton feature value of the skeleton using a second machine learning model obtained by machine learning of a relationship between the skeleton information and the skeleton feature value.

### (Supplementary Note 8)

The image generation method according to Supplementary Note 7, wherein
a parameter of the second machine learning model is updated by
calculating a similarity between a feature value of related image data and a feature value extracted from skeleton information, to be a sample, for each of combinations each of which is configured by combining the skeleton information to be the sample and the related image data,
further calculating, as a skeleton similarity, a similarity between related skeleton information related to a person in the related image data and the skeleton information for each of the combinations, and
further calculating a difference between the calculated similarity and the skeleton similarity for each of the combinations and updating a parameter of the second machine learning model using the calculated difference.

### (Supplementary Note 9)

A computer-readable recording medium storing a program including instructions for causing a computer to execute:
a feature value extraction step of extracting a skeleton feature value of a skeleton from skeleton information specifying a position of each of joints constituting the skeleton; and
an image generation step of generating an image according to the skeleton by inputting the extracted skeleton feature value and a noise image to a machine learning model for estimating noise that has been added to the image and removing the noise from the image using an output result from the machine learning model.

### (Supplementary Note 10)

The computer-readable recording medium according to Supplementary Note 9, wherein
the skeleton information includes at least one of information specifying coordinates indicating positions of joint points, information indicating a body shape, and information indicating a surface of a body that is a basis of the skeleton.

### (Supplementary Note 11)

The computer-readable recording medium according to Supplementary Note 9, wherein
the computer is further caused to execute, in the feature value extraction step, extracting the skeleton feature value of the skeleton using a second machine learning model obtained by machine learning of a relationship between the skeleton information and the skeleton feature value.

### (Supplementary Note 12)

The computer-readable recording medium according to Supplementary Note 11, wherein
a parameter of the second machine learning model is updated by
calculating a similarity between a feature value of related image data and a feature value extracted from skeleton information, to be a sample, for each of combinations each of which is configured by combining the skeleton information to be the sample and the related image data,
further calculating, as a skeleton similarity, a similarity between related skeleton information related to a person in the related image data and the skeleton information for each of the combinations, and
further calculating a difference between the calculated similarity and the skeleton similarity for each of the combinations and using the calculated difference.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

As described above, a posture can be designated at the time of image generation according to the present disclosure. The present disclosure is useful for various systems that perform the image generation.

1. An image generation device comprising:
at least one memory storing instructions; and
at least one processor configured to execute the instructions to:
extract a skeleton feature value of a skeleton from skeleton information specifying a position of each of joints constituting the skeleton; and
generate an image according to the skeleton by inputting the extracted skeleton feature value and a noise image to a machine learning model for estimating noise that has been added to the image and removing the noise from the image using an output result from the machine learning model.

2. The image generation device according to claim 1, wherein
the skeleton information includes at least one of information specifying coordinates indicating positions of joint points, information indicating a body shape, and information indicating a surface of a body that is a basis of the skeleton.

3. The image generation device according to claim 1, wherein
at least one processor extracts the skeleton feature value of the skeleton using a second machine learning model obtained by machine learning of a relationship between the skeleton information and the skeleton feature value.

4. The image generation device according to claim 3, wherein
a parameter of the second machine learning model is updated by
calculating a similarity between a feature value of related image data and a feature value extracted from skeleton information, to be a sample for each of combinations each of which is configured by combining the skeleton information to be the sample and the related image data,
further calculating a similarity between related skeleton information related to a person in the related image data and the skeleton information as a skeleton similarity for each of the combinations, and
further calculating a difference between the calculated similarity and the skeleton similarity for each of the combinations and using the calculated difference.

5. An image generation method executed by a computer, the image generation method comprising:
extracting a skeleton feature value of a skeleton from skeleton information specifying a position of each of joints constituting the skeleton; and
generating an image according to the skeleton by inputting the extracted skeleton feature value and a noise image to a machine learning model for estimating noise that has been added to the image and removing the noise from the image using an output result from the machine learning model.

6. The image generation method according to claim 5, wherein
the skeleton information includes at least one of information specifying coordinates indicating positions of joint points, information indicating a body shape, and information indicating a surface of a body that is a basis of the skeleton.

7. The image generation method according to claim 5, wherein
the extracting the skeleton feature value includes extracting the skeleton feature value of the skeleton using a second machine learning model obtained by machine learning of a relationship between the skeleton information and the skeleton feature value.

8. The image generation method according to claim 7, wherein
a parameter of the second machine learning model is updated by
calculating a similarity between a feature value of related image data and a feature value extracted from skeleton information, to be a sample, for each of combinations each of which is configured by combining the skeleton information to be the sample and the related image data,
further calculating, as a skeleton similarity, a similarity between related skeleton information related to a person in the related image data and the skeleton information for each of the combinations, and
further calculating a difference between the calculated similarity and the skeleton similarity for each of the combinations and using the calculated difference.

9. A non-transitory computer-readable recording medium storing a program for causing a computer to execute:
extracting a skeleton feature value of a skeleton from skeleton information specifying a position of each of joints constituting the skeleton; and
generating an image according to the skeleton by inputting the extracted skeleton feature value and a noise image to a machine learning model for estimating noise that has been added to the image and removing the noise from the image using an output result from the machine learning model.

10. The non-transitory computer-readable recording medium according to claim 9, wherein
the skeleton information includes at least one of information specifying coordinates indicating positions of joint points, information indicating a body shape, and information indicating a surface of a body that is a basis of the skeleton.

11. The non-transitory computer-readable recording medium according to claim 9, wherein
the computer is further caused to execute, in the extracting the skeleton feature value, extracting the skeleton feature value of the skeleton using a second machine learning model obtained by machine learning of a relationship between the skeleton information and the skeleton feature value.

12. The non-transitory computer-readable recording medium according to claim 11, wherein
a parameter of the second machine learning model is updated by
calculating a similarity between a feature value of related image data and a feature value extracted from skeleton information, to be a sample, for each of combinations each of which is configured by combining the skeleton information to be the sample and the related image data,
further calculating, as a skeleton similarity, a similarity between related skeleton information related to a person in the related image data and the skeleton information for each of the combinations, and
further calculating a difference between the calculated similarity and the skeleton similarity for each of the combinations and using the calculated difference.
